(19) United States
(12) Patent Application Publication
(10) Pub. No.: US 2026/0303686 A1
(43) Pub. Date: Oct. 1, 2026

(54) ENSURING MEMORY CONSISTENCY IN REMOTE DIRECT MEMORY ACCESS DATA TRANSFERS

(71) Applicant: Clockwork Systems, Inc., Palo Alto, CA (US)

(72) Inventors: Akram O. Sbaih, San Francisco, CA (US); Katherine Gioioso, Mountain View, CA (US); Yilong Geng, Menlo Park, CA (US); Balaji S. Prabhakar, Palo Alto, CA (US)

(21) Appl. No.: 19/631,612

(22) Filed: Mar. 27, 2026

Related U.S. Application Data
(60) Provisional application No. 63/780,045, filed on Mar. 28, 2025.

(51) Int. Cl. H04L 67/1097; H04L 41/12; H04L 65/1045

(52) U.S. Cl. CPC H04L 67/1097; H04L 41/12; H04L 65/1045

(57) ABSTRACT

A system ensures memory consistency during multi-hop intra-node data transfers in a collective communication environment using GPUs, RDMA network interface cards (R-NICs), and high-bandwidth interconnects. It automatically enforces memory ordering across buses such as PCIe and NVLink while remaining transparent to applications. When a receive request completes, the collective transport logic detects a multi-hop path and repurposes the request into a fence or flush command to ensure RDMA-written data is committed and visible. A subsequent gather operation transfers validated message data from the proxy GPU buffer to the destination GPU over the high-bandwidth link. Completion is reported to the application layer with unchanged semantics. These techniques guarantee data integrity, eliminate explicit synchronization calls, and decouple transmit and receive operations from memory fences, improving reliability and communication performance in multi-hop GPU systems.

### CROSS REFERENCE TO RELATED APPLICATION

This application claims the benefit of US Provisional Application No. 63/780,045, filed on Mar. 28, 2025, which is hereby incorporated by reference herein in its entirety for all purposes.

### TECHNICAL FIELD

This disclosure relates generally to communication systems, and more particularly to systems and methods for transporting messages between hosts over Remote Direct Memory Access (RDMA) networks.

### BACKGROUND

Modern high-performance computing and distributed data-processing environments face growing challenges in efficiently managing data movement and maintaining data consistency across complex network topologies. As computing clusters scale to include many processing devices and RDMA network interface cards (R-NICs), existing transport frameworks often rely on static routing or uniform channel distribution for data transfers. As workloads fluctuate, unbalanced or congested network paths may emerge, leading to degraded throughput, non-uniform load distribution, and bottlenecks in inter-host communication. Messages may be routed through sub-optimal paths, increasing transmission latency and reducing the efficiency of collective communication operations in parallel computing workloads. In addition to communication inefficiencies, data integrity and memory consistency present a significant challenge in large-scale RDMA systems. Send and receive operations may complete asynchronously, allowing subsequent transfers or reads to proceed before all prior in-flight writes are fully committed to memory. Such inconsistencies can lead to incomplete or stale data being accessed by other devices, introducing race conditions or potential data corruption in shared-memory environments.

### SUMMARY

Systems disclosed herein improve data transfer efficiency and reliability in networked environments that utilize RDMA communication between multiple hosts. The system allows hosts with multiple processing devices and RDMA Network Interface Cards (R-NICs) to dynamically mitigate congestion by rerouting data through optimized intra-node communication paths. According to an embodiment, the system communicates messages between a sender host and a receiver host via a collective transport layer. Each host includes multiple processing devices and R-NICs, and the messages are communicated between the hosts through a shared network bus. Examples of processing devices include GPUs (graphical processing units). The system detects network congestion between the sender host and the receiver host and, in response, selects a proxy processing device based on its topological proximity to a target R-NIC of the sender host. Upon identifying the proxy, the system scatters message data from a source processing device of the sender host to the proxy processing device using a high-bandwidth intra-node interface, thereby avoiding congestion-affected paths. The proxy processing device transmits the message data via the target R-NIC through the bus to the receiver host. At the receiver host, the system delivers the transmitted message data to a destination processing device through a destination R-NIC, completing the end-to-end communication.

According to an embodiment, the system improves data transfer reliability and ordering in RDMA environments that utilize intra-node multi-hop communication paths. A system dynamically determines the transport type of incoming receive requests and enforces data-commit guarantees when multi-hop intra-node routing is detected. This ensures that all message data are fully committed to memory and synchronized before being accessed or processed by higher-level applications. According to an embodiment, the system receives, via the R-NIC, a receive request containing message data destined for a specified target processing device. The R-NIC stores the received message data in a proxy buffer on a receiving processing device. The system analyzes the transport path associated with the request to determine whether the transfer occurred over a multi-hop intra-node path, such as one involving multiple intermediate devices within the same computing node. The system may determine that the receive request involved a multi-hop intra-node transport path by determining that the receive request was sent through a proxy exchange network (PXN) interface configured to manage intra-node message forwarding between processing devices. When the system determines that the transfer used a multi-hop route, a control module repurposes the receive request into a memory barrier request to ensure data integrity. The memory barrier request issues operations such as a memory fence or memory flush to commit all message data from intermediate caches or buffers to the proxy buffer before any further data handling occurs. After the message data are committed, the system performs a gather operation that transfers the data from the proxy buffer on the receiving device to the target processing device. Once the transfer and synchronization are completed, the R-NIC reports completion of the receive operation to the application layer, allowing normal application-level processing to proceed.

Embodiments of the invention include computer-implemented methods described herein, non-transitory computer readable storage media storing instructions for performing steps of the methods disclosed herein, and systems comprising one or more computer processors and computer readable non-transitory storage medium to perform steps of the computer-implemented methods disclosed herein.

### BRIEF DESCRIPTION OF THE DRAWINGS

FIG. 1 is an exemplary system environment for implementing communications in a CTL, in accordance with an embodiment.

FIG. 2 illustrates an exemplary configuration and data flow sequence for implementing the collective transport layer method using high-bandwidth intra-node interconnects in conjunction with RDMA communication, in accordance with an embodiment.

FIG. 3 illustrates a process for improving data communication between a sender host and a receiver host using high-bandwidth interconnects in combination with PCIe and RDMA protocols, in accordance with an embodiment.

FIG. 4 shows the system architecture of the RDMA receive module,, in accordance with an embodiment.

FIG. 5 illustrates an exemplary process for ensuring memory consistency during a multi-hop intra-node transport within a collective communication system, in accordance with an embodiment.

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### DETAILED DESCRIPTION

In high-performance computing (HPC), large-scale AI training, and other distributed workloads, collective communication systems transport messages between hosts using a Collective Transport Layer (CTL). The CTL performs inter-node communication using RDMA networks such as InfiniBand or RoCE, implemented via R-NICs connected to the host's PCIe (Peripheral Component Interconnect Express) tree. Some architectures use isolated PCIe subtrees with no interconnecting links, thereby limiting the CTL's choice of R-NICs to use for communication. Network congestion may occur as a result of PCIe bottlenecks that happen within a computer when several devices such as GPUS and R-NICs share the same PCIe bus and send or receive data simultaneously and exceed the bus's bandwidth limit or a NIC transmits or receives data faster than the PCIe connection can process. When network congestion occurs, packet delays increase, and packets may even be dropped or need to be resent.

The disclosed system overcomes these limitations by introducing a proxy buffer, multi-hop intra-node transport method at the CTL. The method stages network-bound data on a GPU located near an optimal R-NIC, uses high-bandwidth intra-node buses (e.g., NVLink) to move data between GPUs before and after RDMA transmission, and abstracts these operations behind a high-level software interface. On the receive side, it repurposes completed RDMA receive requests into in-place memory fence/flush operations before the gather step, ensuring correct memory ordering without burdening the application with explicit fencing calls. By combining topology-aware GPU/NIC selection, fast intra-node data hops, and transparent memory consistency enforcement, the system mitigates PCIe bottlenecks, maintains performance under adverse topology changes, and ensures data integrity, addressing shortcomings of existing solutions that cannot dynamically reroute through faster intra-node links or guarantee correctness in multi-hop RDMA paths.

### System Environment

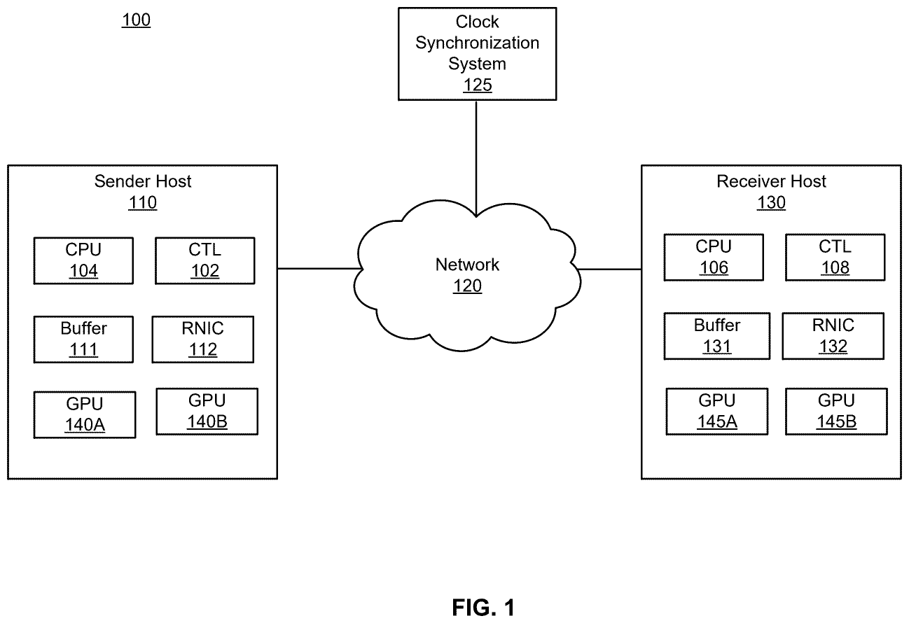

FIG. 1 is an exemplary system environment for implementing communications in a CTL, in accordance with an embodiment. As depicted in FIG. 1, the system environment 100 includes sender host 110, network 120, receiver host 130, and a clock synchronization system 125. Each host includes a CPU, a collective transport layer (CTL) module, a buffer, one or more R-NICs and one or more GPUs. For example, sender host 110 includes CPU 104, CTL 102, buffer 111, R-NIC 112, and GPUs 140A, 140B and receiver host 130 includes CPU 106, CTL 108, buffer 131, R-NIC 132, and GPUs 145A, 145B. Other embodiments may include more or fewer components, for example, a host may include more GPUs. A host may also be referred to as a node. While only one of each of sender host 110 and receiver host 130 is depicted, this is merely for convenience and ease of depiction, and any number of sender hosts and receiver hosts may be part of system environment 100.

The system environment 100 is configured to implement a collective transport layer (CTL) utilizing high-bandwidth intra-node interconnects beyond PCIe. The system environment 100 includes a sender host 110 and a receiver host 130 connected by a network 120 that enables RDMA communication between nodes. RDMA enables one computer to directly access the memory of another computer without involving the remote system's central processing unit (CPU) or operating system. This direct memory-to-memory access allows data to be transferred with very low latency and minimal overhead compared to conventional communication methods that require buffer copies and context switching. RDMA operates over specialized network interfaces such as InfiniBand and RDMA over Converged Ethernet (RoCE), providing high bandwidth and efficient data movement essential for distributed computing and high-performance applications.

Each host is equipped with one or more R-NICs 112 and 132 that transmit and receive RDMA messages to and from the network 120. An R-NIC is a hardware component that enables high-performance data communication between hosts in a distributed computing environment. An R-NIC allows one system to directly place data into the memory of another system without involvement from the remote system's central processing unit or operating system, thereby reducing latency and freeing compute resources for application workloads. It operates as an endpoint of an RDMA network, managing network transmission queues, data path logic, and direct memory access operations. The R-NIC interfaces with the host system over the PCIe bus and connects to remote nodes through network protocols such as InfiniBand or RoCE. This direct, kernel-bypassing communication model enables zero-copy data exchange between devices, supporting both one-sided and two-sided operations for message passing, read/write, and atomic transactions. By minimizing CPU overhead and memory copies, the R-NIC provides deterministic and persistent high-bandwidth performance that is foundational for modern high-performance computing, deep learning clusters, and large-scale data center architectures.

Each host includes one or more graphics processing units (GPUs). For example, the sender host includes GPUs 140A, 140B and the receives host includes GPUs 145A, 145B. The GPUs provide high-bandwidth computing resources for message preparation and processing. On a host, the GPUs may be interconnected by a high-speed link, allowing communication within the same node to bypass PCIe bottlenecks. In operation, data messages generated at the sender GPU 140A may be scattered to GPU 140B through the high-bandwidth intra-node link before being transmitted via RNIC 112 across network 120 to the receiver host 130. At the receiver host 130, incoming messages are received by R-NIC 132, placed into buffer 131 associated with GPU 145A or 145B depending on proximity, and gathered across the high-bandwidth intra-node link for further processing. This system environment demonstrates how the collective transport layer establishes multi-hop data paths that combine both intra-node and inter-node communication channels to achieve improved throughput, balanced load, and reliable message consistency.

During data transfers, the PCIe bus serves as the connection between the R-NIC and the rest of the host system, including the CPU, GPUs, and memory devices. The R-NIC uses the PCIe interface to perform direct memory access (DMA) operations, allowing it to read or write data directly into host or GPU memory without requiring intervention from the CPU. The PCIe bus carries command, address, and data packets between the R-NIC and other devices on the PCIe tree, coordinating memory transactions and ensuring ordered delivery. In this configuration, the R-NIC acts as a PCIe endpoint, while the CPU or PCIe switch mediates access between endpoints such as GPUs. Therefore, the PCIe bus provides the essential data path for RDMA transfers initiated or completed by the R-NIC, though it may become a bandwidth bottleneck when multiple high-traffic devices share the same PCIe links, an issue addressed through the use of high-bandwidth intra-node interconnects beyond PCIe.

When R-NICs communicate over the PCIe bus, several common bottlenecks can limit performance. A primary source of congestion arises when multiple R-NICs share the same PCIe link, causing contention for limited bandwidth. This contention can saturate the uplinks closer to the PCIe root complex, especially in systems where numerous R-NICs are installed. Additionally, PCIe's topology, organized as a hierarchical tree, can create “hot spots” at shared switch nodes or bridges, where traffic from several endpoints converges. The non-uniform memory access (NUMA) nature of these systems can exacerbate delays when data must travel across PCIe subtrees to reach R-NICs located far from the originating GPU or CPU. Another bottleneck occurs when the PCIe tree is split into isolated subtrees, restricting the collective transport layer's ability to route data through alternative R-NICs. The system as disclosed supplements PCIe with high-bandwidth intra-node interconnects such as NVLink or UALink to bypass these performance limitations.

The central processing unit (CPU) 104, 106 coordinates RDMA transfers between the R-NICs and GPUs primarily through setup, control, and management of memory and communication contexts. The CPU initiates and configures RDMA operations by establishing queue pairs, registering GPU or host memory regions with the R-NIC, and maintaining the address mappings required for direct access. During these initialization and control phases, the CPU ensures that both the R-NIC and the GPU operate within the same memory protection and translation domains, allowing the R-NIC to perform direct memory access without additional host intervention. Once an RDMA transfer begins, the R-NIC executes data movement directly between memory and the network, bypassing the CPU in the critical data path. Nevertheless, the CPU remains responsible for orchestration tasks, such as issuing control commands, handling completion notifications, managing errors, and maintaining synchronization between computation on the GPU and data transfers performed by the R-NIC. This coordination enables efficient communication while minimizing CPU overhead during high-performance operations.

The CTL module manages communication between hosts participating in distributed computing operations and provides intelligent control over data transport paths within and across nodes. The CTL module monitors performance metrics of networked devices, such as R-NICs and graphics processing units (GPUs), to detect congestion or imbalances in data flow. It analyzes throughput, latency, and link utilization across the PCI express (PCIe) topology to identify potential bottlenecks that could reduce communication efficiency. Upon detection of congestion, the CTL module dynamically reconfigures data routing by selecting optimal intra-node pathways and redistributing traffic through high-bandwidth interconnects such as NVlink or UAlink to bypass saturated PCIe links. The module coordinates with GPU control and RDMA subsystems to allocate proxy or alias buffers, register these buffers for direct memory access, and initiate multi-hop transfers that balance traffic load between R-NICs. Additionally, the CTL module synchronizes data transmission events, manages memory registration consistency across devices, and ensures message ordering through the use of internal fences or flush mechanisms. The CTL module enhances scalability and optimizes throughput for collective communication operations. A memory fence or a memory flush operation is a type of memory barrier operation. Accordingly, the CTL module may perform any type of memory barrier operation. The memory barrier operation ensures that memory reads and writes occur in a defined sequence, preventing processors, compilers, or devices from reordering instructions in ways that could lead to inconsistent data visibility across threads, processors, or devices. A memory barrier may include different types of operations, such as read barriers, write barriers, or full barriers, depending on whether it restricts reads, writes, or both.

A memory barrier operation ensures that all writes to memory that are part of a write operation are committed to memory before any the data is subsequently processed. Committing a write to memory ensures that any data received by a device, such as a processor, GPU, or network card, in a write operation is stored and finalized in the physical memory space. For example, when a device performs a write operation, the data may initially be placed in temporary locations, such as caches, buffers, or write queues instead of immediately reaching main memory (e.g., DRAM or GPU memory). These temporary stages help improve speed but can cause inconsistencies if another device tries to read the data before the writes are complete. Committing the write ensures that all pending data in these intermediate storage stages is flushed out and made visible and accessible to other processors or devices. After a commit, any read operation on the data written is able to access correct data, and the system can safely proceed to the next step, such as data processing, without risk of stale or partial information.

A memory fence enforces precise order of operations to maintain data correctness whenever multiple devices or processing units, such as GPUs, CPUs, or R-NICs are performing memory reads and writes. For example, when an R-NIC performs a direct memory access (DMA) write into a GPU's memory via RDMA, the data may still reside temporarily in write buffers or caches rather than being fully committed to GPU memory. If the GPU immediately begins reading from that memory region to perform a gather or computation before the R-NIC's writes are complete, the GPU may read incomplete or stale data. This can cause corrupted results, invalid computations, or synchronization mismatches across devices. The system performs a memory fence operation to prevent such premature reads or out-of-order writes that creating inconsistent views of memory among devices. This issue is more likely in multi-hop scenarios, such as when message data travels from one GPU through another GPU (via NVLink) and through an R-NIC (via PCIe), since each hop introduces independent caches and buffers. By inserting a memory fence after the DMA write completes, but before the next read or gather operation, the system enforces completion and visibility of all pending writes. The fence flushes write buffers and ensures that the data written by the R-NIC is fully committed to GPU memory. Consequently, subsequent GPU reads are guaranteed to see the correct, finalized data. In this way, the memory fence resolves ordering hazards, prevents partial write visibility, and maintains consistency across all cooperating devices during high-performance RDMA and GPU data transfers.

The sender host 110 further includes a buffer 111, and the receiver host 130 includes a corresponding buffer 131, both storing message data for RDMA operations in coordination with their respective R-NICs. Buffers 111 and 131 serve as the temporary storage regions supporting RDMA communication between the sender host 110 and the receiver host 130. Specifically, buffer 111 at the sender host holds message data that is prepared for transmission through the corresponding R-NIC 112, while buffer 131 at the receiver host stores incoming message data received through R-NIC before it is processed or moved to the target GPU memory. These buffers maintain data flow coordination between the GPUs and the RNICs, allowing efficient transfer, synchronization, and memory consistency in the collective transport layer system

The clock synchronization system 125 maintains precise timing across the hosts to ensure consistency of message transmission and ordered memory access. Clock synchronization system 141 synchronizes one or more components of each host, such as the NIC, the kernel, or any other component within the system. Details of clock-synchronization are described in commonly-owned U.S. Pat. No. 10,623,173, issued Apr. 14, 2020, the disclosure of which is hereby incorporated by reference herein in its entirety. Each host is synchronized to an extremely precise degree to a same reference clock, enabling precise timestamping across hosts regardless of host location, bandwidth conditions of the host, jitter, and the like.

Different components shown in FIG. 1 may communicate via Peripheral Component Interconnect Express (PCIe) bus, a high-speed serial interface that provides standardized communication between the processors, memory controllers, and peripheral components of a computer system. For example, R-NICs and GPUs are connected within a PCIe tree of a host. The R-NICs communicate with the CPU, system memory, and other PCIe-attached devices through this bus. Similarly, each GPU connects to the host system and the R-NICs via PCIe for data transfers. However the system may use an alternate high-bandwidth intra-node link like NVLink or UALink for direct GPU-to-GPU communication.

The PCIe bus serves as the primary data path connecting devices such as graphics processing units (GPUs), network interface cards (NICs), and storage controllers to the central processing unit (CPU) or root complex. PCIe uses multiple lanes to transmit and receive data in parallel, enabling scalable bandwidth depending on device requirements. Each device communicates by exchanging packets over these point-to-point lanes rather than the shared bus used in older architectures, which allows direct and efficient data transfer with low latency. The PCIe topology consists of a hierarchical tree structure, where the CPU or root complex occupies the top level and devices connect downstream through switches or bridges. This structure supports hot-plugging, device discovery, and dynamic bandwidth allocation. Despite its efficiency, PCIe bandwidth can become a bottleneck when multiple high-demand devices compete for access, especially in GPU-accelerated servers.

Examples of high-speed links for connecting GPUs include NVLink and UALink, NVLink is a high-speed, direct interconnect technology developed to enable fast data exchange between multiple graphics processing units (GPUs) or between GPUs and CPUs within a single computing node. Unlike traditional PCIe connections, which rely on a shared bus architecture with limited bandwidth, NVLink provides high-bandwidth, low-latency point-to-point communication channels that allow GPUs to share memory and coordinate workloads more efficiently. This facilitates coherent data access, reduced dependence on host memory, and improved scalability for multi-GPU applications. NVLink supports multiple parallel links, each capable of delivering substantial data throughput, allowing aggregate bandwidth far exceeding that of conventional PCIe interconnects. Because of these capabilities, NVLink enhances performance in high-performance computing, artificial intelligence, and large-scale data processing workloads by allowing GPUs to operate cooperatively and exchange large volumes of data in real time without a bottleneck at the PCIe interface.

UALink is a high-speed, open-standard interconnect technology designed to enable efficient communication between multiple graphics processing units (GPUs) and other accelerators within a single computing node. It provides a scalable, low-latency data path that allows devices to share memory and exchange data directly without relying solely on the PCIe bus, which can become bandwidth-limited in multi-GPU configurations. UALink supports peer-to-peer connectivity, enabling GPUs to access each other's memory spaces for operations such as collective computation, deep learning training, and data analytics. Through its open architecture, UALink fosters interoperability between hardware vendors while maintaining high throughput and efficient data movement. This direct inter-device communication improves overall system performance by reducing dependency on host CPU intervention and minimizing latency in workloads requiring frequent or large-scale data transfers among accelerators.

The system performs scatter and gather operations that enable efficient data movement between multiple graphics processing units (GPUs) within a host system using high-speed links such as NVLink or UALink. In a scatter operation, message data generated or stored in a source GPU is distributed to one or more target or proxy GPUs connected through a high-bandwidth intra-node interconnect. This operation transfers the data directly across GPU memory systems without passing through the system's central processing unit or the PCIe bus, thereby reducing latency and avoiding bandwidth bottlenecks. The scatter function allows message data to be staged on a GPU that is topologically closer to an R-NIC, enabling faster transmission through the R-NIC to an external network. Conversely, in a gather operation, data received from the network and placed on the proxy GPU's memory is collected and transferred across the same high-speed link back to the destination GPU for final processing. The gather phase ensures message completeness and maintains data consistency by consolidating distributed data fragments into the destination GPU memory before computation resumes. Together, the scatter and gather operations utilize the high-speed interconnect to achieve low-latency, high-throughput communication between GPUs and network interfaces, improving overall performance of collective transport within heterogeneous computing environments.

According to an embodiment, the gather operation executes directly over NVLink or UALink to transfer validated data between GPUs. In environments lacking high-bandwidth interconnects, the system performs gathers through shared system memory where proxy buffers are accessible to all nodes. Additional embodiments allow batched gather operations to proceed after a single fence enforcement, enabling efficient group synchronization for multiple message segments.

### System Architecture and Data Flow Sequence

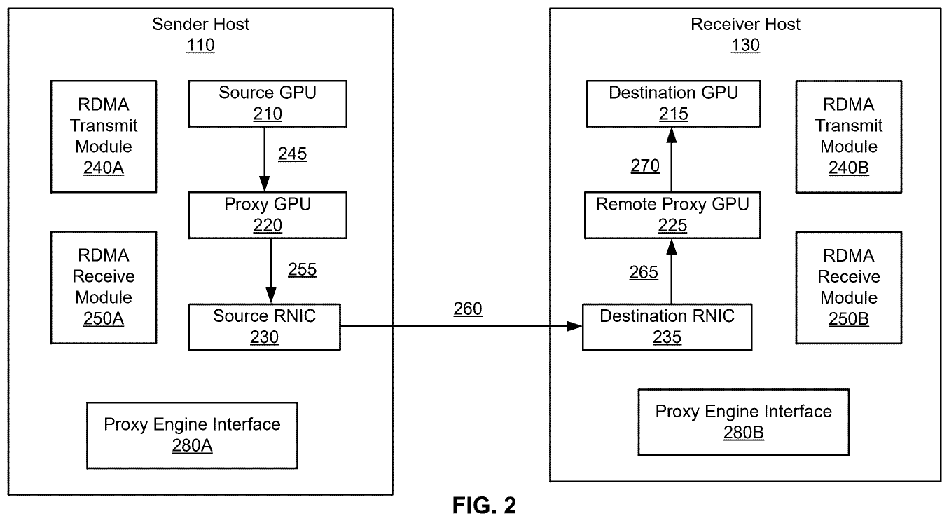

FIG. 2 illustrates an exemplary configuration and data flow sequence for implementing the collective transport layer method using high-bandwidth intra-node interconnects in conjunction with RDMA communication, in accordance with an embodiment. The system includes a sender host 110 and a receiver host 130 interconnected through a network fabric. Within the sender host 110, a source GPU 210 performs computation and generates message data for transmission. The sender host also includes a proxy GPU 220 that is topologically proximate to a source R-NIC 230. Within the receiver host 130, a remote proxy GPU 225 is topologically close to a destination R-NIC 235. The destination GPU 215 represents the final processing endpoint for the incoming message data. The arrows shown in the figure correspond to the steps of the process carried out to transfer data efficiently across hosts using both NVLink and PCIe connections.

Each host includes an RDMA transmit module 240 and an RDMA receive module 250, which coordinate remote direct memory access operations between participating nodes. On the sender host 110, the RDMA transmit module 240 manages the process of sending message data residing in GPU memory to the network for delivery to the remote node. It interfaces with the proxy GPU 220 and the source R-NIC 230 to initiate data movement, encapsulate transmission requests, and ensure that the data from the proxy or alias buffer registered with the R-NIC is correctly transmitted over the network fabric. The RDMA transmit module 240 offloads this operation from the CPU, allowing zero-copy data transfer directly between device memory and the network interface for high performance and low latency.

On the receiver host 130, the RDMA receive module 250 handles the inbound side of the data path. It receives message data from the destination R-NIC 235 and writes the incoming data directly into a registered proxy or alias buffer located on the remote proxy GPU 225. The RDMA receive module 250 ensures proper placement of data into GPU memory and the generation of appropriate completion or notification signals once the transfer is complete. Together, the RDMA transmit and receive modules operate asynchronously to perform end-to-end RDMA operations between GPUs across hosts, leveraging direct memory access to bypass intermediate CPU involvement and thereby achieve efficient, high-throughput message transport within the collective transport layer system.

In step 245, the collective transport layer selects the proxy GPU 220 within the sender host that is closest to the source R-NIC 230 in the PCIe topology and allocates a proxy or alias buffer on that GPU, registering it with the R-NIC. In step 255, message data produced by the source GPU 210 is scattered to the proxy GPU 220 through a high-bandwidth intra-node connection such as NVLink or UALink, thereby avoiding congestion on the PCIe bus. In step 260, the proxy GPU 220 transfers the scattered message over PCIe to the source R-NIC 230, which performs an RDMA transmission of the data across the inter-node network to the receiver host 130. In step 265, the destination R-NIC 235 delivers the incoming data to a proxy or alias buffer allocated on the remote proxy GPU 225 that resides closest to it in the PCIe tree. Finally, in step 270, the data is gathered from the remote proxy GPU 225 to the destination GPU 215 via the high-bandwidth intra-node bus, ensuring that the message reaches the correct GPU memory with reduced PCIe contention and improved end-to-end throughput. Through this sequence, the system coordinates intra-node and inter-node data movement to optimize collective communication performance while maintaining data consistency across devices.

Each host includes a proxy engine interface 280, a programmable interface for managing proxy and interconnect operations. The CTL provides structured methods that transparently perform buffer aliasing and interconnect switching without introducing platform-specific complexity. This interface unifies intra-node GPU communication and inter-node RDMA transmission under a single layer, making the system hardware-agnostic. The interface defines a software layer for managing memory operations and data movement across multiple network interface cards (NICs) in a server environment. It is designed for use in high-performance computing or collective communication frameworks, such as those utilizing RDMA. Through this interface, the system can allocate, alias, and transfer data regions among NICs while enforcing memory-consistency guarantees. All requests executed through the proxy engine interface 280 are subject to memory-consistency controls that include triggering memory barrier requests (such as memory fence or flush operations) to ensure full data commitment before buffers are accessed or released by other devices. This mechanism guarantees that all prior write and receive operations complete and become visible before any subsequent memory or transfer instructions are issued, thereby preserving deterministic data coherence across NIC boundaries.

The proxy engine interface 280 provides several APIs (application programming interfaces) as methods that can be invoked. The constructor PxnEngine() initializes the proxy engine instance, configuring internal structures used to map physical and virtual NIC regions and prepare control paths for memory-consistency enforcement.

A proxyAddNic method registers a NIC with the engine, associating an integer identifier and human-readable name to the interface. This enables the host to manage coordination of buffers and proxy memory regions across multiple network interfaces while establishing a NIC context for subsequent operations.

A proxyAllocRegion method allocates a proxy memory region on the NIC specified by the identifier. The method generates an alias pointer that serves as a virtual handle for the region. Before completing, the allocation request triggers a memory-barrier process that validates that any previous data writes or communications are committed to the NIC's local memory to maintain consistency across RDMA targets.

A proxyFreeRegion method deallocates the specified proxy region previously created by proxyAllocRegion. A memory-barrier sequence is issued before freeing the region to ensure that all prior read or write operations to the proxy region have completed and that data has been properly flushed from intermediate caches.

A proxyAlias method creates an alias mapping of an existing memory region to a NIC-specific address space. The aliasing process allows shared visibility of a given memory segment to multiple NICs under unified address translation control. The method includes a barrier step to confirm that the region to be aliased is synchronized and not being modified concurrently. A proxyReveal method resolves an alias back to its underlying physical or virtual memory address. When invoked, this method activates a memory-synchronization check confirming that the alias state reflects the latest committed data before revealing the target address for direct DMA or CPU access.

A proxyScatter method transfers or scatters data from a source memory address to one or more NIC regions using high-bandwidth intra-node pathways. Prior to issuing the scatter operation, the PxnEngine enforces a memory-barrier request to ensure that all message data at the source address has been committed and is globally visible, thereby preventing stale or inconsistent data transmission.

A proxyGather method aggregates or gathers data from one or more proxy NIC regions into a destination buffer or registered memory area. Before execution, the operation triggers a barrier request to ensure that all scatter or write operations associated with the proxy regions have completed. The gathered data is thus guaranteed to represent the most current and consistent version across all NICs involved in the bonded configuration.

Accordingly, the methods of the proxy engine interface 280 enable dynamic memory-region management and high-speed, multi-NIC data exchange while integrating automatic memory-consistency enforcement. Every operation ensures ordered visibility and completeness of memory actions across all network and processor boundaries, supporting deterministic and safe data-movement performance in RDMA and collective communication systems.

According to an embodiment, the system establishes, maintains, and terminates communication sessions between graphics processing units (GPUs) and R-NICs in a manner that ensures persistent high-performance connectivity while enabling clean resource management when sessions are deactivated. During initialization, the CTL creates a communication context for each GPU-to-R-NIC pair. This process involves discovering the PCIe hierarchy and any available high-bandwidth intra-node interconnects on the host, such as NVLink or UALink, to assess device proximity and efficient bandwidth routes. The CTL assigns identifiers linking GPUs with corresponding R-NICs based on their physical topology and network accessibility. Once these associations are formed, proxy or alias buffers are pre-allocated on selected GPUs close to their assigned R-NICs and prepared for RDMA registration to streamline message forwarding operations.

Following topology discovery, the CTL configures queue pairs and memory registration handles that facilitate direct RDMA operations between each GPU and its paired R-NIC. These configurations establish send and receive queues, memory keys, and operation contexts to enable subsequent RDMA reads, writes, and zero-copy transfers either through standard PCIe pathways or accelerated intra-node communication links. The CTL maintains mapping metadata throughout the session, which tracks each GPU's local memory regions, registered proxy buffers, and their associated network memory keys. This metadata enables seamless synchronization across multiple GPUs and R-NICs while ensuring consistent routing for data paths that may dynamically switch between connection modes or load-balanced devices.

During teardown, the CTL performs a controlled release of resources to maintain system and session integrity. The teardown phase includes invalidating RDMA keys to prevent unintended memory access, freeing or reclaiming proxy buffers allocated on GPUs, and deleting communication context entries associated with each GPU-to-R-NIC pair without disrupting other active connections managed by the CTL. In one embodiment, the teardown sequence may include coordinated flushing operations that ensure all pending transmissions are completed before memory regions are deregistered. Alternative embodiments may incorporate checkpointing, allowing registered contexts to be restored later for applications requiring rapid reconnection. This comprehensive initialization and teardown process enables reliable setup, sustained load balancing during RDMA communication, and orderly disconnection of GPU-to-R-NIC channels while optimizing performance across heterogeneous intra-node and inter-node transport environments.

According to an embodiment, the system detects, responds to, and mitigates transmission errors that occur during GPU-to-R-NIC communication over either the PCIe bus or high-bandwidth intra-node links. The CTL provides continuous monitoring of completion statuses and error codes reported by the R-NIC for data transfers initiated from GPU memory. This monitoring allows the CTL to identify specific fault conditions, including transmission failures, timeouts, and data corruption, that may arise from physical link congestion or transient synchronization issues. The CTL parses error reports from the R-NIC to correlate specific failures with message identifiers and device contexts, enabling targeted recovery rather than system-wide resets.

Once a fault is detected, the CTL initiates a recovery sequence that retransmits failed message data directly from GPU memory through the proxy or alias buffer previously registered with the R-NIC. This re-transmission process may bypass intermediary CPU memory and preserve zero-copy semantics to maintain throughput. The CTL also updates protocol-level state information, flagging the retransmission event for higher-layer collective communication components to maintain transactional integrity across distributed peers. The CTL may throttle subsequent transmissions or reroute data through alternate intra-node links, such as NVLink or UALink, when degraded PCIe paths or overloaded R-NICs are detected.

In one embodiment, error conditions are resolved using adaptive retry mechanisms, where retransmission counters and delay intervals are dynamically tuned based on historical fault patterns and device response time. In another embodiment, error detection may include cyclic redundancy checks (CRCs) or end-to-end message authentication tags validated by the CTL to verify data integrity after retransmission. Alternative implementations may employ redundant proxy buffers or mirrored memory registration to sustain service continuity while one path undergoes recovery. Additionally, the CTL logs all fault events for diagnostic and telemetry purposes, enabling predictive maintenance and long-term optimization of communication routes. Through these techniques, the system maintains reliable GPU-to-R-NIC data exchange while minimizing recovery time and preventing recurring faults on degraded or congested communication links.

According to an embodiment, the CTL dynamically adapts to hardware changes involving GPUs or R-NICs to maintain seamless and uninterrupted communication. The CTL continuously monitors the host topology for events such as insertion, removal, activation, or deactivation of devices connected within the PCIe tree. Upon detecting such a topology change, the CTL updates its internal topology map to reflect changes in connectivity and bandwidth availability across GPUs and R-NICs. This ensures that the CTL maintains an accurate representation of all communication paths, including their physical proximity and link attributes that determine data transfer performance.

When a GPU or R-NIC is removed, the CTL invalidates outdated proxy buffer registrations and releases corresponding RDMA keys to prevent invalid memory references or orphaned data structures within the transport layer. If devices are added or reactivated, the CTL recalculates GPU-to-R-NIC proximity metrics using updated bandwidth measurements and hop counts within the PCIe tree. The CTL dynamically reassociates active proxy buffers with GPUs that exhibit optimal proximity or connectivity to the available R-NICs. This reassignment ensures that data forwarding operations, such as scatter and gather, continue to use the most efficient intra-node paths, leveraging high-bandwidth interconnects like NVLink or UALink when available.

After recalculating device mappings, the CTL reestablishes RDMA registrations between the newly assigned proxy GPUs and their corresponding R-NICs. It reconfigures scatter-gather routes and buffer aliases across intra-node and inter-node links to restore full communication capability. In one embodiment, this reconfiguration occurs automatically through the CTL management layer without requiring user intervention, allowing live reconfiguration in clusters where devices frequently scale in or out. In alternative embodiments, the CTL may store pre-computed fallback configurations to minimize reinitialization latency, or use predictive analytics to anticipate upcoming hardware changes and prepare proxy allocations in advance. Through this adaptable mechanism, the system maintains continuous and efficient data transport even under dynamic topological changes, ensuring resilience and high performance in GPU-accelerated, distributed communication environments.

### Process of Communication via Collective Transport Layer

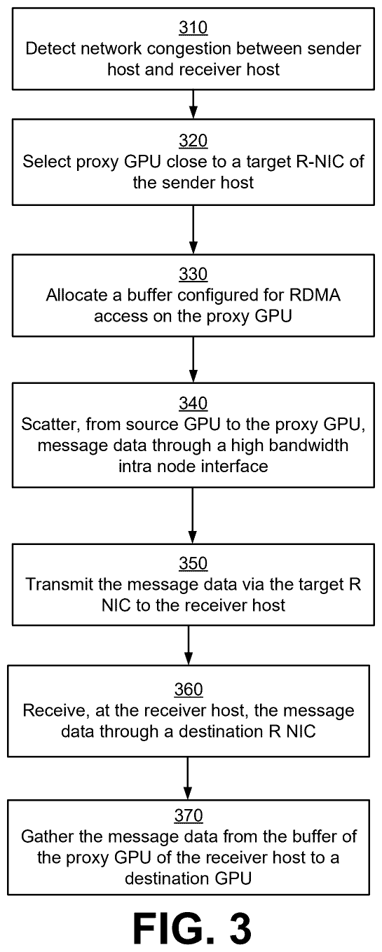

FIG. 3 illustrates a process performed within the collective transport layer system for improving data communication between a sender host and a receiver host using high-bandwidth interconnects in combination with PCIe and RDMA protocols, in accordance with an embodiment. The sequence of operations enables intelligent data routing and buffer management between multiple GPUs and R-NICs located on each host. The steps described in this flowchart perform congestion detection, topology-aware GPU selection, buffer allocation and registration, message scattering and gathering, and RDMA-based transmission and reception.

The process begins with the system detecting network congestion between the hosts and dynamically reconfiguring memory pathways to bypass bottlenecks by leveraging high-speed intra-node links such as NVLink or UALink. The collective transport layer module detects 310 network congestion between the sender host and receiver host by monitoring data transfer latency, throughput, or signal contention across PCIe links connecting corresponding R-NICs. In response to this detected congestion, the topology management module selects 320 a proxy GPU on the sender host that is topologically closer to a target R-NIC in the PCIe tree. This selection minimizes PCIe hop distance and ensures optimal positioning for outbound RDMA communication. The memory management module allocates 330 on the selected proxy GPU a staging or alias buffer configured for RDMA access and registers the buffer with the target R-NIC to enable direct memory operations through PCIe. Once registration is complete, the GPU communication module scatters 340 message data from a source GPU to the proxy GPU via the high-bandwidth intra-node interconnect, such as NVLink or UALink, allowing message fragments to be efficiently distributed while avoiding PCIe congestion.

Following the scatter operation, the RDMA transmit module transmits 350 the message data from the proxy GPU to the target R-NIC over PCIe for outbound messaging to the receiver host. The RDMA receive module at the receiver host receives 360 the message data from the destination R-NIC into a proxy or alias buffer allocated on a receiving GPU that is physically closer to that destination R-NIC in the PCIe topology. Finally, the GPU communication module on the receiver host gathers 370 the message data from the proxy GPU's buffer to the destination GPU using the high-bandwidth intra-node interconnect. This gather operation completes the multi-hop data transport by restoring full message integrity at the destination GPU while ensuring low latency and balanced data throughput across the entire communication path. Together, these interconnected steps demonstrate an adaptive method enabling collective transport operations that effectively utilize alternate high-bandwidth interconnects beyond PCIe to improve RDMA performance across distributed computing nodes.

According to an embodiment, the CTL monitors network conditions within a host system to detect congestion on the PCIe bus that may degrade data transfer performance between devices such as GPUs and R-NICs. The detection process involves continuous collection and evaluation of data transfer metrics from one or more R-NICs installed on the host's PCIe tree. The CTL analyzes throughput, latency, link utilization, and completion rates to determine whether multiple R-NICs are contending for a shared PCIe link. Such contention can occur when multiple R-NICs transmit or receive at high rates through a common upstream connection leading to the PCIe root complex, resulting in reduced effective bandwidth for one or more devices. By comparing the measured throughput against a predefined or dynamically determined performance threshold, the CTL identifies degradation caused by congestion or oversubscription of PCIe resources.

When measured throughput or latency deviates from expected performance, particularly in shared or split PCIe topologies, the CTL determines that a bottleneck condition exists near the root or across isolated subtrees of the PCIe architecture. Responsive to this detection, the CTL activates a bypass or rerouting mechanism that utilizes a high-bandwidth intra-node bus, such as NVLink or UALink, to offload traffic away from the congested PCIe path. In one embodiment, the CTL dynamically reassigns data flow from a GPU linked to an overloaded R-NIC to another GPU that is topologically closer to a less loaded or better-connected R-NIC, transferring the data internally over the high-bandwidth interconnect before initiating RDMA transmission. In another embodiment, performance thresholds may be adaptive, enabling the CTL to account for workload type, data size, or measured contention history. Alternative implementations may employ hardware-assisted PCIe monitoring, firmware counters, or software-based telemetry to evaluate link utilization in real time. Through these mechanisms, the CTL proactively detects and mitigates PCIe congestion, ensuring sustained high throughput and balanced data flow across the node while leveraging available intra-node interconnect capacity.

According to an embodiment, the CTL determines which graphics processing unit (GPU) should act as the proxy GPU for message forwarding based on a combination of system topology awareness and dynamic load evaluation. The core concept of the claim involves selecting the GPU that is both physically closest to the target R-NIC in the PCIe hierarchy and sufficiently under-utilized to accommodate additional proxy or staging operations without introducing latency or performance degradation. To achieve this, the CTL first accesses or constructs a PCIe topology map of the host node that describes the relative positions and hop distances between GPUs, R-NICs, and intermediate PCIe switches or bridges. Using this map, the CTL determines the proximity of each GPU to the selected R-NIC by evaluating the number of PCIe hops, available bandwidth per link, and overall NUMA affinity.

Once proximity is identified, the CTL analyzes real-time utilization metrics for each GPU, including queue depths, active memory transfer rates, and compute workload indicators such as kernel occupancy, memory throughput, or DMA engine availability. The CTL compares these metrics to identify a GPU that has sufficient idle capacity to host a proxy buffer and participate in message forwarding. If multiple GPUs share similar proximity characteristics, the CTL may apply weighted criteria favoring GPUs with lower data transfer utilization or higher available memory bandwidth.

In one embodiment, the CTL integrates these metrics through a scoring process that ranks GPUs according to physical locality and load responsiveness, dynamically updating selections as workloads change. In another embodiment, the CTL may maintain a historical performance dataset to predict congestion and preemptively assign proxy roles before bottlenecks occur. Alternative implementations may further incorporate temperature thresholds, power utilization, or interconnect topology data for heterogeneous architectures containing XPUs, FPGAs, or custom accelerators. Through this adaptive selection mechanism, the CTL ensures that the chosen target GPU minimizes PCIe traversal distance while providing adequate computational and memory resources for proxy buffer allocation and efficient message forwarding operations between intra-node and inter-node communication paths.

According to an embodiment, the system registers GPU memory for RDMA access by bridging the PCIe interface between a GPU and R-NIC. The core concept of this claim involves exposing a specific address range of a proxy or staging buffer allocated on the target GPU to the R-NIC, allowing direct network communication without requiring CPU involvement. The implementation begins when the CTL performs a memory registration operation over the PCIe link to identify and expose the GPU's address range accessible for RDMA. During this process, the CTL collaborates with the GPU driver and R-NIC control logic to validate memory permissions and ensure that the R-NIC can directly perform read and write transactions on the GPU buffer.

After this registration, the CTL associates a unique network memory key with the registered buffer region. The memory key is used by the RDMA protocol to facilitate zero-copy data transfers, allowing the R-NIC to place or retrieve data directly into the GPU memory space during transmit or receive operations. The CTL updates its internal metadata to reflect the mapping between the proxy GPU buffer and the corresponding R-NIC so that all subsequent RDMA transactions reference the correct physical address and authorization key. This structure minimizes latency by removing redundant data staging through host CPU memory.

In alternative embodiments, the CTL may support dynamic re-registration of the proxy buffer when GPU workloads or memory topology change, or perform registration across multiple GPUs attached to different PCIe subtrees to balance network load. In some implementations, hardware assistance or vendor-specific APIs may be used to streamline the registration step while retaining CTL control over memory mapping and consistency. The system maintains high-bandwidth communication between GPUs and R-NICs while leveraging RDMA capabilities for direct, low-latency access to GPU device memory.

The CTL implements a synchronization mechanism to ensure ordered, consistent, and hazard-free data transfers between the source graphics processing unit (GPU) and the target GPU during intra-node message forwarding. The core concept of this claim is that the CTL manages inter-GPU timing and memory consistency along the high-bandwidth interconnect, such as NVLink or UALink, so that data scattered from the source GPU to the target GPU is correctly written and visible before being forwarded to the R-NIC. To achieve this, the CTL coordinates transmission timing between the GPUs to control the pacing of data blocks moved over the high-speed bus, ensuring that no partial or out-of-order transfers interfere with concurrent scatter or gather operations.

Once the scatter stage completes, the CTL issues synchronization primitives such as memory fences or flush operations. These primitives guarantee that all data writes to the proxy or alias buffer on the target GPU are complete and globally visible before the RDMA transmission begins. The CTL verifies the completion of pending write operations, either through hardware acknowledgment or software state polling, before initiating the transfer from the target GPU to the associated R-NIC. This write verification step ensures that no stale or incomplete data reaches the network interface, preserving data integrity through the transfer sequence.

The CTL maintains a persistent synchronization state machine that tracks the scatter, fence, and transmit phases between GPUs. This state tracking prevents data hazards that may arise from overlapping scatter and gather operations in multi-GPU environments where separate data streams operate concurrently. In one embodiment, the synchronization state may be implemented as control metadata within the CTL's communication context, enabling parallel operations to proceed safely while still maintaining strict order for dependent transfers. Alternative embodiments may employ event-driven signaling mechanisms, such as completion queues or semaphore-based synchronization between GPUs, to achieve similar ordering guarantees with minimal latency overhead. Through these techniques, the CTL ensures reliable and consistent inter-GPU coordination, enabling high-throughput and low-latency forwarding of RDMA data while maintaining memory coherence across all participating devices.

### Alternative Embodiments of Efficient Communications Using the CTL

According to various embodiments, the system extends flexibility, resilience, and performance of the CTL under diverse interconnect and hardware conditions. The system enables the CTL to dynamically determine when to introduce an intra-node transport hop using high-bandwidth links such as NVLink or UALink. The CTL monitors PCIe saturation, detects failed or unavailable R-NICs, and recognizes split or isolated PCIe subtrees. When any such condition arises, the CTL proactively establishes an alternative communication path by routing data through a GPU-to-GPU interconnect, ensuring continuity of message forwarding without relying solely on congested or disconnected PCIe links. In alternative embodiments, the CTL may employ a pre-computed redundancy table or real-time topology scanner to dynamically switch between direct PCIe and intra-node routes depending on network and bus conditions.

The system performs intra-node data transfer by employing a buffer aliasing approach. The CTL designates memory regions on a selected GPU as proxy buffers that mirror their original counterparts while remaining transparent to higher communication layers. This abstraction allows RDMA operations to be performed across heterogeneous hardware systems without revealing underlying architectural or vendor-specific details. The aliasing mechanism simplifies platform integration by dynamically binding alias pointers to the most efficient access path, whether PCIe, NVLink, or UALink. In some embodiments, the alias binding occurs during runtime as part of the CTL's memory registration process, while alternative implementations may instantiate static mappings to minimize software overhead in latency-critical environments.

The system performs adaptive load balancing across multiple GPUs and R-NICs. Here, the CTL continuously measures bandwidth utilization, latency, and link health across PCIe and high-bandwidth GPU interconnects. Based on these real-time metrics, the CTL dynamically schedules scatter and gather operations through the path offering the highest instantaneous throughput. This intelligent routing ensures even distribution of network load and prevents localized bottlenecks. In certain embodiments, the load-balancing techniques may employ feedback control loops or machine learning estimators to predict future congestion and reassign transfers preemptively.

The system enhances reliability through memory consistency enforcement. When a receive operation completes on a proxy buffer, the CTL transforms that request into an in-place fence or flush command to guarantee completion of pending writes before a gather operation begins. This ensures that received data is fully committed to GPU memory, maintaining correctness while decoupling fence control from explicit transmit and receive logic. Alternative implementations may use lightweight ordering tokens or event-driven callbacks to issue fences automatically in multi-hop transfers, thereby optimizing performance without compromising synchronization fidelity.

The system provides topology-aware self-management. The CTL continuously observes system-wide topological and performance metrics for GPUs and R-NICs, detecting bandwidth degradation, link failures, or resource reconfigurations. It autonomously reassociates active proxy buffers with GPUs that are closer to healthy R-NICs or possess available high-bandwidth paths, ensuring sustained performance even as devices are dynamically added, removed, or repartitioned. In other embodiments, the reconfiguration process may leverage cached topology states or predictive path optimization, enabling near-instant recovery and minimal interruption to ongoing RDMA operations.

### Technical Improvements of Efficient Communications at the CTL

The techniques disclosed provide improvements that achieve enhanced performance, bandwidth efficiency, and consistency in data transfers across heterogeneous interconnect architectures. The system enables the CTL to dynamically utilize multiple bus technologies, such as PCIe, NVLink, and UALink, based on topology awareness, real-time bandwidth, and resource availability. This integration allows message data to be routed over an optimal intra-node or inter-node path while reducing latency, mitigating congestion, and preventing bandwidth underutilization that typically arises from static PCIe routing architectures.

The techniques further introduce mechanisms that coordinate communication between graphics processing units (GPUs) and R-NICs without requiring intervention from the central processing unit (CPU). By allocating proxy or alias buffers on GPUs located topologically closer to R-NICs and performing dynamic registration and mapping directly in device memory, the system enables zero-copy RDMA operations that minimize CPU overhead, improve memory efficiency, and reduce power consumption. The CTL manages message scattering and gathering through high-bandwidth intra-node interconnects, thereby transforming conventional single-hop RDMA transfers into multi-hop, topology-aware flows optimized for modern multi-GPU and multi-NIC topologies.

These techniques also use a novel memory-consistency mechanism that guarantees ordered data visibility without interrupting the transport pipeline. Through the automatic conversion of completed receive requests into in-place fence or flush operations, the CTL maintains synchronization across GPUs, ensuring data validity while decoupling expensive fence calls from the main transmission path. This improvement delivers hardware-level consistency guarantees using software-controlled operations, a capability that traditional RDMA mechanisms lack.

The system additionally provides dynamic reconfiguration by continuously monitoring link utilization, PCIe saturation, and device availability. When a GPU or R-NIC is added, removed, or fails, the CTL recalculates topological proximity and reassigns proxy buffers and communication contexts in real time, maintaining uninterrupted message delivery. This adaptive responsiveness represents a technical enhancement to network resilience and resource optimization not achievable through conventional static configuration techniques. The disclosed techniques increase throughput, reduce queuing delay, lower CPU utilization, and improve system scalability across multi-bus, multi-device architectures by performing performance-optimized communications.

### Ensuring Memory Consistency in RDMA Transfers

According to an embodiment, the system ensures memory consistency in RDMA data transfers by maintaining correct ordering and visibility of data across multiple devices and buses. For example, memory consistency may be required during multi-hop data transfers in collective transport systems that include both GPU-to-GPU and GPU-to-R-NIC pathways. When messages traverse different interconnects, such as NVLink or UALink between GPUs and PCIe between GPUs and R-NICs, conventional RDMA mechanisms can complete receive operations before all corresponding memory writes are fully committed. This can allow subsequent gather or read operations to access incomplete or stale data, leading to inconsistencies and potential data corruption, particularly in systems where transmit and receive operations are decoupled for performance reasons.

To address this problem, the disclosed system repurposes completed receive requests into in-place fence or flush operations. When a receive operation finishes, the CTL intercepts its completion event and extends the request's lifecycle by transforming it into a memory synchronization operation rather than finalizing it immediately. The same request handle is used as a flush request to ensure that all pending GPU writes are completed and visible across the involved devices. Only after the flush or fence operation has confirmed full data commitment does the CTL release the request for completion, allowing subsequent gather or computation steps to proceed with consistent data. This process is performed transparently within the CTL, without requiring modifications to higher-layer applications or communication APIs, maintaining backward compatibility while ensuring data integrity.

As a result, the system guarantees write ordering and memory consistency in multi-hop GPU data transfers without adding new synchronization overhead visible to applications. By decoupling memory fencing from application-level request handling and integrating it directly within the CTL, the system achieves low-latency, error-free operation across heterogeneous transport layers. Furthermore, the method improves reliability during scenarios such as failover, topology rebalancing, or intra-node proxy forwarding, where additional device hops are introduced. These techniques enhance correctness and throughput of GPU-accelerated collective communication. These techniques reduce complexity and execution stalls associated with conventional explicit synchronization models. Execution stalls associated with conventional explicit synchronization models occur when a processor, GPU, or other computing device must pause execution until all pending memory operations are explicitly confirmed as complete. In such models, applications or upper software layers invoke synchronization primitives, such as flushes or memory fences, at predefined points within the code. These operations force the system to halt new data transfers or computations until memory writes and reads are fully ordered and visible across devices. This explicit synchronization introduces latency and idle cycles because hardware must wait for acknowledgment from all relevant devices (e.g., GPUs, CPU, RDMA cards). In multi-hop or distributed data-transfer scenarios, where data passes across several buses or devices, these stalls compound and drastically reduce throughput. By contrast, the techniques disclosed repurpose receive requests automatically into fence or flush operations performed within the collective transport layer, eliminating the need for upper layers to issue explicit synchronization calls. This prevents unnecessary pauses in GPU execution or RDMA communication, thereby maintaining continuous data movement and improving end-to-end performance.

### System Architecture of RDMA Receive Module

According to an embodiment, the RDMA receive module 250 in a host implements the processes for implementing memory consistency. Details of the RDMA receive module 250 are further described herein.

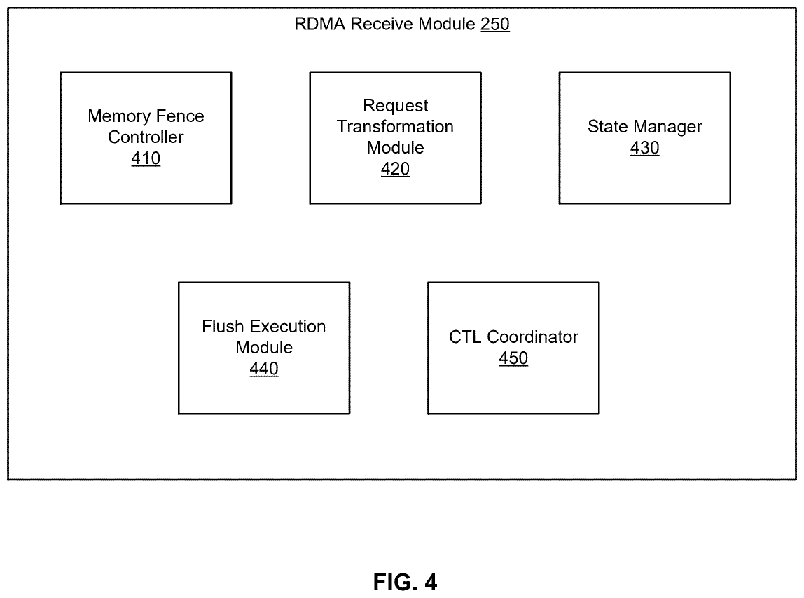

FIG. 4 shows the system architecture of the RDMA receive module 250, in accordance with an embodiment. As shown in FIG. 4, the RDMA receive module 250 includes a memory fence controller 410, a request transformation module 420, a state manager 430, a flush execution module 440, and a CTL coordinator 450. In some embodiments, additional or alternative components to those shown in FIG. 4 may be included in the RDMA receive module 250. Each module is described in detail next.

The memory fence controller 410 manages issuance and execution of flush or fence operations triggered upon completion of a receive request. It ensures that all writes to GPU memory are fully committed before a subsequent gather or dependent operation is initiated by the CTL. The memory fence controller 410 may be implemented as a hardware-assisted queue integrated with device drivers, or as a firmware-managed logic layer interfacing with GPU and R-NIC DMA engines. In one embodiment, the module automatically detects receive completions and injects fence signals into the request queue without explicit commands from higher-level applications. In another embodiment, the controller interfaces with a synchronization driver to enforce ordering guarantees across GPU memory domains, operating transparently within the CTL layer to maintain low latency and coherence across multiple device interconnects.

The request transformation module 420 performs in-place conversion of a completed receive request into a memory fence or flush sequence. This module detects the completion of a network receive event, retains the original request handle, and defers the completion response to higher layers until all consistency enforcement actions are finished. By hijacking the completion workflow, the module ensures that the application sees a unified receive operation even as internal post-processing occurs. The request transformation module 420 can be implemented as an extension of the CTL queue manager or within the device driver layer that manages RDMA request lifecycles. In one embodiment, the module interacts directly with the flush execution module 440 to initiate GPU-level write completion, while in another embodiment, it can trigger microcode-based command execution on the GPU or R-NIC firmware for direct fence signaling.

The state manager 430 maintains control and synchronization metadata for all receive, flush, and gather operations managed by the RDMA receive module 250. It tracks request states, including pending memory writes, completed network transfers, and verified flush events, ensuring correct ordering among interdependent operations. The state manager 430 may store operation metadata in a control table shared with the CTL coordinator 450, providing a unified view of all outstanding data-transfer lifecycles. In some embodiments, it supports lock-free data structures optimized for high-concurrency environments, enabling parallel tracking of hundreds of concurrent transfers. Alternative implementations may embed finite state machines (FSMs) to represent dual-phase operations, such as receive-plus-flush or scatter-plus-gather workflows. The module reports state transitions back to the CTL coordinator 450 so that the correct completion semantics are maintained, even in distributed transport contexts.

The flush execution module 440 performs the physical memory commit verification required to maintain data consistency. Once triggered by the request transformation module 420, this module commands GPU drivers or memory controllers to execute cache invalidations, buffer flushes, or memory fences to ensure that incoming RDMA data is visible to all relevant processing units. The flush execution module 440 can operate through driver APIs that expose low-level DMA or BAR-mapped address spaces to initiate hardware flush instructions. In one embodiment, the module supports multisession parallelization, where fence operations for one receive request can overlap with subsequent transactions. In another embodiment, the module uses GPU-specific primitives to minimize synchronization delay, sending completion notifications to the state manager 430 once all writes are committed.

The CTL coordinator 450 provides overall sequencing and timing control among the receive, fence, and gather stages executed during multi-hop data transfers. This module manages request ordering within the collective transport layer, ensuring that repurposed receive requests complete only after fenced memory consistency is guaranteed. The CTL coordinator 450 may coordinate with both the RDMA transmit and receive modules across different hosts to maintain global ordering and to report fully completed operations to application-level collectives. Implementation may include an event-driven scheduler that aligns scatter-gather timing with RDMA completion queues. In one embodiment, the CTL coordinator 450 handles deferred completion events in batch form to improve throughput, while in another, it maintains fine-grain sequencing for latency-sensitive transfers. By integrating queue management with fence sequencing, the CTL coordinator 450 ensures high-performance communication while enforcing deterministic memory ordering across all devices involved in the collective transport system.

### Process for Ensuring Memory Consistency

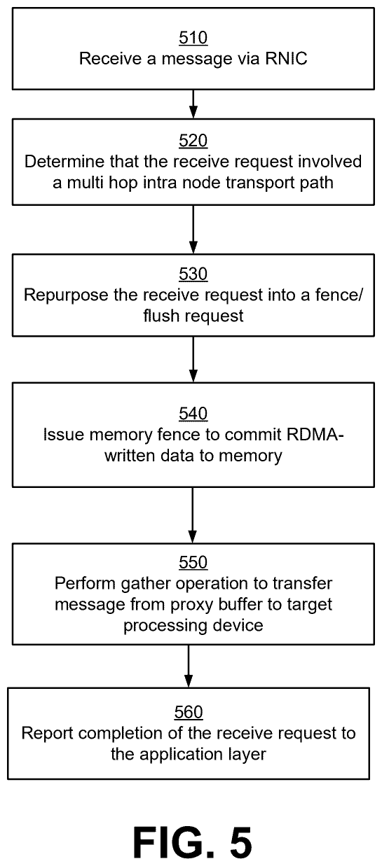

FIG. 5 illustrates an exemplary process for ensuring memory consistency during a multi-hop intra-node transport within a collective communication system, in accordance with an embodiment. The process is executed by the modules of the RDMA receive module 250 operating in coordination with the CTL. The method ensures that message data transmitted over a high-bandwidth intra-node path and an R-NIC maintains strict memory ordering before the data is consumed by subsequent operations or processing units. The process provides automatic synchronization and transparency to the application layer, allowing transmit and receive functions to remain decoupled from explicit fence or flush commands while still guaranteeing data integrity.

During initialization and context establishment, the CTL coordinator 450 initiates a context setup sequence that prepares the collective transport environment for proper data handling and memory consistency control. The CTL coordinator 450 first establishes the system topology by identifying GPUs, R-NICs, and their corresponding PCIe or high-bandwidth intra-node interconnect relationships. Using this information, the state manager 430 records GPU to R-NIC mapping information and generates topology metadata that associates each GPU with its nearest R-NIC based on hop distance and available bandwidth. The request transformation module 420 configures communication handles and control structures required for in-place request management, enabling efficient tracking and repurposing of future receive requests within the CTL. The memory fence controller 410 initializes a set of synchronization parameters and default fence policies according to the detected topology. In coordination with the flush execution module 440, these parameters define when memory consistency enforcement must be applied, such as when multi-hop intra-node transport paths are detected. Once the context initialization is complete, the CTL coordinator 450 finalizes registration of proxy or alias buffers and activates RDMA communication links, ensuring that memory registration states and topology mapping are synchronized across GPU and R-NIC domains. As a result, the system begins subsequent data transfer processes with full awareness of inter-device topology and predetermined conditions for invoking memory consistency mechanisms.

The RDMA receive module 250 receives 510 message data via an R-NIC from a remote transmitting host. The incoming data is written by the R-NIC to a proxy buffer located in GPU memory on the receiving processing device. The CTL coordinator 450 oversees this reception to ensure that the transfer parameters correspond to the appropriate communication context within the multi-hop transport configuration, coordinating subsequent operations among the RDMA receive and GPU synchronization components.

Once the data transfer completes, the request transformation module 420 determines 520 that the completed receive request corresponds to a multi-hop intra-node transport path, such as one involving a proxy GPU and an NVLink data exchange. This determination prompts internal transformation of the pending request within the CTL's control queue. The request transformation module 420 repurposes 530 the completed receive request in-place into a memory barrier request, for example, a memory fence or a memory flush request. Repurposing the receive request keeps the request handle active so that the application layer perceives no change in request status. This ensures seamless integration while enabling the CTL to perform additional consistency checks prior to marking the request as fully complete. If the request transformation module 420 determines that a request received corresponds to a single hop transfer the request transformation module 420 allows the receive request to complete without repurposing the receive request to the memory barrier request.

Upon detecting completion of a receive operation, the request transformation module 420 transforms the request a memory fence or memory flush request and places it into a monitored deferred-completion state instead of immediately reporting completion. According to an embodiment, the repurposing of the request is performed in place by using a handle of the receive request to perform a memory barrier operation. According to an embodiment, the state manager 430 maintains a deferred-completion queue that tracks pending operations, associating each pending operation with its corresponding GPU-memory region and required synchronization state. The memory fence controller 410 signals the state manager 430 once all memory fence or memory flush activities have been completed successfully after which the CTL coordinator 450 issues the completion signal to the higher-level application. This preserves transparent API behavior while ensuring no premature signaling occurs.

After the transformation, the memory fence controller 410 issues 540 a memory fence operation targeting the proxy buffer associated with the completed transfer. The memory fence operation guarantees that all RDMA-written data within the proxy buffer is fully committed to GPU memory and visible to downstream processing stages before any gather or computation occurs. Depending on implementation, the memory fence operation may be executed through GPU driver calls, DMA synchronization commands, or low-level memory flush primitives. The flush execution module 440 performs these operations, confirming successful completion and notifying the state manager 430 that the memory is now consistent and accessible.

Following successful memory-commit verification, the CTL coordinator 450 performs 550 a gather operation, transferring the message data from the proxy buffer on the receiving GPU to the final destination GPU through a high-bandwidth intra-node interconnect such as NVLink or UALink. The CTL coordinator 450 orchestrates timing of this gather to ensure it occurs immediately after the fence has validated the memory consistency, maintaining efficient data flow across devices without additional software overhead.

Once all synchronized data operations have completed, the state manager 430 reports 560 completion of the receive request to the application layer. From the application's perspective, this completion notification matches conventional receive semantics, even though the underlying process has already performed an implicit flush and memory validation. By maintaining this abstraction, the CTL ensures transparent operation and compatibility with existing APIs.

During the completion and logging process, the state manager 430 coordinates with the CTL coordinator 450 to record and finalize the results of memory fence and flush activities performed by the RDMA receive module 250. After the flush execution module 440 confirms that all RDMA-written data has been fully committed to GPU memory, the state manager 430 logs 710 the transition of the request state from pending to completed. The CTL coordinator 450 reports 720 the completion status to the higher-level application layer, preserving standard receive semantics while internally documenting the dual-phase execution sequence that included the fence enforcement. Concurrently, the memory fence controller 410 captures 730 latency statistics associated with the fence operation, such as total flush duration and memory write verification time. These metrics, together with event records generated by the flush execution module 440, are aggregated into a diagnostic log file or performance database. In some embodiments, the logging subsystem may include time-stamped entries of each consistency event and statistical summaries for later analysis. Alternative embodiments may asynchronously export collected data to an external monitoring or tuning utility, allowing administrators to perform auditing, debugging, and optimization of memory consistency operations across the collective transport layer environment.

According to an embodiment, an error recovery and verification process after any fence or flush operation completes. The flush execution module 440 verifies the success of each memory commit by cross-checking DMA acknowledgment signals and comparing expected data-commit counters against GPU memory status registers. If the consistency verification detects incomplete writes, stale data, or any deviation in expected buffer states, the CTL coordinator 450 triggers the recovery procedure. The memory fence controller 410 initiates a local re-flush of the affected region, while the state manager 430 updates the error log and marks the recovery event for diagnostic tracking. In cases of persistent inconsistency, the CTL coordinator 450 may direct retransmission of the message via the RDMA link to restore correct data placement before gather operations proceed. In alternative embodiments, hardware-assisted verification performed within GPU drivers may further accelerate detection, allowing the flush execution module 440 to complete real-time consistency checks during fence enforcement without interrupting normal transport flow.

According to an embodiment, in the fence scheduling and prioritization process, the memory fence controller 410 operates in conjunction with the CTL coordinator 450 to determine 860 the optimal ordering of pending flush and fence operations. The fence scheduling logic dynamically evaluates GPU workload, RDMA queue utilization, and intra-node link bandwidth to decide sequencing and priority. For example, under high concurrency, the CTL coordinator 450 may schedule multiple flush operations as consolidated batches, while ensuring that critical transfers complete before non-critical requests. In other embodiments, a weighted scheduling policy implemented in the memory fence controller 410 assigns higher priority to synchronization events associated with latency-sensitive GPU tasks or collective reduce operations. The flush execution module 440 executes 870 these scheduled fences in the determined order, reporting results back to the state manager 430 for bookkeeping and timing adjustment.

According to an embodiment, the system performs dynamic path detection and fence activation. The CTL coordinator 450 continuously monitors active communication paths between GPUs and RNICs to determine whether data transfers are occurring across multi-hop intra-node routes, such as through proxy GPUs connected by NVLink or other high-bandwidth interconnects. The state manager 430 maintains a real-time topology map containing GPU-to-RNIC associations and transfer history. When the CTL coordinator 450 detects that a new data flow traverses such a multi-hop intra-node path, it automatically triggers the memory-fence path handling procedure. In this embodiment, the CTL dynamically toggles memory consistency enforcement by notifying the memory fence controller 410 and the flush execution module 440 to prepare fence operations for any subsequent receive or gather requests involving the identified path. Alternative embodiments may use passive detection integrated with RDMA completion queues or micro-telemetry data from device drivers to identify topological routes before enabling fence activation logic. According to an embodiment, the CTL coordinator 450 determines that the receive request was involved a multi hop intra node transport path by determining that the receive request was sent through a proxy engine interface 280.

Throughout these operations, the system maintains decoupling between transmit and receive paths and the memory-fence mechanism during normal execution to preserve low-latency performance. The memory fence controller 410 automatically activates only when a multi-hop intra-node transport is detected, enabling intelligent enforcement of consistency constraints without requiring intervention from higher-level software. Collectively, these coordinated steps allow the RDMA receive module 250 to guarantee data correctness and synchronization across complex interconnect hierarchies while sustaining high throughput and seamless integration with existing collective communication systems.

### Alternative Embodiments for Ensuring Memory Consistency in RDMA Transfers

In some embodiments, the high-bandwidth intra-node interconnect used to perform the gather operation comprises NVLink, UALink, PCIe peer-to-peer links, or any hardware interconnect providing sufficient bandwidth to enable direct device-to-device communication among GPUs, CPUs, FPGAs, or TPUs. These interconnects allow scatter and gather operations to be executed without routing data through host memory, facilitating low-latency transfer between accelerators within the same node. The interconnect may be selected at runtime by the CTL based on system topology, link health, or available bandwidth. In alternative embodiments, the CTL dynamically switches between multiple high-bandwidth paths to avoid congestion while preserving memory ordering.

The memory fence may be implemented by hardware-level synchronization primitives native to the system architecture. For GPU-resident data, the fence may be initiated using GPU firmware or driver instructions that trigger cache invalidation and memory-barrier enforcement. For host-based systems, a CPU memory barrier or PCIe switch-initiated ordering primitive performs an equivalent function, ensuring memory visibility and completion of pending writes. These barriers may be executed as explicit firmware instructions, driver-level signals, or bus-level ordering commands. In heterogeneous environments, the CTL may select a platform-specific fence mechanism based on the device type and the memory domain involved in the transfer.

In another embodiment, repurposing of the receive request into a fence or flush request may be accomplished within the R-NIC firmware. Upon detecting completion of a DMA transfer, the R-NIC firmware triggers an internal routine that suspends completion signaling to the CTL or higher-layer driver until the corresponding fence or flush operation is executed. This firmware-assist allows consistency enforcement to occur immediately after DMA completion, minimizing software latency while maintaining synchronization between the R-NIC and GPU memory domains. The firmware may optionally record state pointers for recovery or retransmission in the event of incomplete flush execution.

Determining whether a memory fence is required may further include detecting bad NUMA affinity or a topology that includes isolated PCIe subtrees. In such cases, the CTL identifies inefficient GPU-RNIC pairings or long PCIe paths by consulting the system's topology map. When poor locality or isolated subtrees are detected, multi-hop transfers are flagged, and the fence enforcement sequence is automatically enabled to guarantee consistent visibility along indirect routes. Conversely, enforcement of the fence may be selectively suppressed for operations that occur entirely within a common PCIe subtree or on direct GPU-RNIC connections, reducing unnecessary synchronization overhead and improving system throughput.

The fence or flush request, when executed, drains DMA write buffers, invalidates GPU caches, and orders all memory transactions according to a defined release/acquire or stricter coherence model. This step ensures that no write-combining or delayed commit persists in hardware queues or caches that would otherwise expose stale data to subsequent reads. Various embodiments may use either a relaxed or a strong ordering protocol, depending on workload and protocol requirements.

Following successful fence execution, the gather operation proceeds over high-bandwidth pathways such as NVLink, UALink, PCIe peer-to-peer links, or shared system memory. The CTL may employ peer-to-peer memory copy engines or direct GPU DMA to enable bulk transfer of validated message data from proxy buffers to destination devices. In certain embodiments, a fallback gather path may use host-shared system memory when direct interconnects are unavailable, preserving functional compatibility across heterogeneous topologies.

Fence enforcement logic may be implemented within the CTL driver, embedded in GPU or R-NIC device drivers, or integrated into higher-level communication middleware libraries such as NCCL or MPI. Driver-level implementation provides low latency and direct hardware control, while middleware integration simplifies portability and user-space visibility. In one embodiment, a kernel service module or transport runtime interfaces these layers to manage synchronization between the hardware and application tiers.

At the application interface level, transparency is maintained by preserving receive request identifiers and semantics. The repurposed request continues to behave as a standard receive operation, reporting completion only after fence execution and data consistency are guaranteed. This design allows legacy applications to benefit from consistency enforcement automatically, without requiring code modification or explicit memory barrier invocation.

Fence enforcement may be intelligently skipped for active low-latency protocols or network modes in which equivalent ordering guarantees are inherently provided. For example, if a transport protocol has already applied a hardware-assisted fence or guarantees write visibility before issuing completion events, the CTL may bypass redundant enforcement to preserve efficiency. Similarly, conditional enforcement may depend on message size, latency sensitivity, or congestion metrics, smaller messages or those routed through non-congested paths may complete without invoking barrier operations, while larger or path-intensive transfers invoke stricter consistency handling.

In some embodiments, the proxy buffer used to store incoming message data is pre-allocated and registered for RDMA access prior to message receipt. Registration is managed through a proxy allocation API that maps an original application buffer address to a staging buffer on the proxy GPU or device with closer proximity to the R-NIC. This mapping allows RDMA hardware to directly access GPU memory and enables seamless scatter and gather execution across multiple devices, maintaining efficiency and full compliance with the memory consistency mechanism.

In certain embodiments, the system performs an in-place transformation of a completed receive request into a fence or flush operation based on dynamically detected trigger conditions. These triggers include identification of multi-hop topologies such as bad NUMA affinity or cross-subtree transfers within a host's PCIe hierarchy. The CTL analyzes topology maps and automatically activates consistency enforcement when indirect pathways through proxy GPUs are used for multi-hop routing. In other embodiments, the CTL selectively applies the transformation only for specific protocol types such as RDMA or hybrid RDMA/TCP transactions, ensuring that high-performance protocols invoking their own ordering primitives are not redundantly fenced. Additional variations employ latency measurements or buffer state indicators to initiate fence enforcement, where sustained delay, saturated queues, or incomplete memory-commit signals serve as conditions for transforming receive requests into synchronized flush commands.

Hardware-specific embodiments enable fencing using platform-native mechanisms that operate close to the physical memory domain. In one variant, GPU firmware executes memory-barrier instructions following RDMA writes, providing full visibility for device memory coherency. In another, the R-NIC hardware autonomously issues a flush command immediately after DMA completion, ensuring the ordering of RDMA transactions without CPU intervention. Additional configurations allow PCIe switch controllers or accelerator interconnect controllers (NVLink or UALink) to manage fence propagation between distinct domains. In more heterogeneous systems, fencing may be extended to transitions between accelerator architectures, such as GPU-to-FPGA or GPU-to-TPU exchanges, where specialized coherence instructions synchronize memory views across differing device architectures.

At different software layers, the repurposing mechanism may reside wholly within the CTL API, such as an engine interface supporting proxy allocation or scatter/gather operations. In other embodiments, fencing occurs at a device-driver level within GPU or R-NIC drivers, allowing tighter control of DMA completion and memory barrier execution. Middleware integrations with collective communication frameworks such as NCCL, MPI, or specialized HPC libraries enable broader deployment, automatically invoking fence enforcement where multi-hop paths are detected during compute or training workloads.

The scope of transparency to the application can vary. In one fully transparent mode, the application remains unaware of internal fence logic, receiving only the original request completion semantics. In a semi-transparent mode, metadata signals may be reported to the application for diagnostic, performance-tuning, or audit purposes, allowing developers to track fence invocation frequency. Alternate embodiments expose optional API hooks for enabling or disabling automatic fencing based on workload patterns, providing flexibility in balancing performance and correctness.

The system supports multiple fence types and consistency models. Hardware implementations may use CPU-side cache flushes combined with PCIe posted-write drains, GPU global memory barriers for device-level consistency, or hybrid CPU/GPU coherency fences for unified memory spaces. Depending on workload sensitivity, the CTL selects relaxed, release/acquire, or strong ordering semantics to align with latency or throughput goals. For instance, relaxed semantics may apply to streaming data paths, whereas strong or release/acquire modes serve critical synchronization for stateful collective operations.

Conditional fencing provides further optimization. The CTL bypasses redundant enforcement if a low-latency protocol has already applied an equivalent ordering primitive or when hardware guarantees RDMA write visibility before signaling transfer completion. Selective enforcement may also depend on message size or congestion thresholds, where smaller transactions or confirmed low-latency links omit barrier invocation to conserve processing resources while maintaining correctness.

Broader hardware environments supported by these techniques include multi-socket CPU platforms with NUMA domains, systems comprising mixed accelerator types such as GPUs, AI chips, and FPGAs, and disaggregated compute fabrics interconnected via emerging technologies like CXL. These embodiments extend consistency protection and automatic flush sequencing across heterogeneous hardware, enabling multi-hop RDMA communication with predictable ordering, higher throughput, and robust data integrity in advanced distributed computing architectures.

### Technical Improvements of Ensuring Memory Consistency in RDMA Transfers

The techniques disclosed provide significant practical improvements to computer technology by ensuring ordered and reliable data transfer in complex multi-device environments, particularly those featuring multi-hop GPU and RDMA communication paths. The system enhances the performance and integrity of distributed hardware architectures by introducing an automated memory-ordering mechanism that operates transparently within the collective transport layer without requiring modification to application interfaces or higher-level protocols. This configuration enables hardware components, such as GPUs, RNICs, and PCIe switches, to cooperate in performing multi-stage data transfers while maintaining strict memory consistency across heterogeneous interconnects.

The techniques disclosed repurpose the receive request in-place into a fence or flush operation, thereby eliminating the latency and complexity inherent in explicit synchronization models that traditionally stall execution while waiting for memory commits. The system transforms ordinary device-level communication into a dynamic synchronization process that validates memory writes automatically before data is consumed or forwarded, reducing error rates while maintaining continuous data flow. Integrating the fence logic directly within the collective transport layer improves the functioning of the computer by securing memory correctness during GPU-to-GPU transfers and RDMA transactions without adding overhead or interrupting communication.

Additionally, the disclosed methods optimize system resource management by decoupling transmit and receive operations from manual fencing while selectively enforcing consistency only when multi-hop paths are detected. This conditional enforcement allows the hardware to bypass unnecessary synchronization for direct or low-latency pathways, resulting in faster operation and reduced contention on PCIe and NVLink buses. The system effectively restructures device behavior through distributed coordination of memory barriers, flush execution, and state management modules that interact in real time, thereby improving hardware utilization and enabling higher aggregate bandwidth across clustered GPUs. By automating memory-ordering enforcement at the transport layer, the system is optimized for consistent, high-performance RDMA and GPU communication.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for reconciling configuration settings for imported resources through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for data transfer using remote direct memory access (RDMA), comprising:
receiving, via an RDMA network interface card (R-NIC), a receive request comprising message data destined for a target processing device, the message data stored in a proxy buffer on a receiving processing device;
determining that the receive request was transmitted via a multi-hop intra-node transport path;
responsive to determining that the receive request was transmitted via a multi-hop intra-node transport path, repurposing the receive request into a memory barrier request, wherein the memory barrier request is configured to commit message data of the receive request to the proxy buffer before further processing of the message data;
performing a gather operation to transfer the message data from the proxy buffer on the receiving processing device to the target processing device; and
reporting completion of the receive request to an application layer.

2. The method of claim 1, wherein the memory barrier request is for performing one of a memory fence operation or a memory flush operation.

3. The method of claim 1, wherein the receive request is a first receive request, the method further comprising:
receiving, at the receiving processing device a second receive request;
determining that the second receive request corresponds to a single-hop transfer; and
responsive to determining that the second receive request corresponds to a single-hop transfer, allowing the receive request to complete without repurposing the receive request to the memory barrier request.

4. The method of claim 1, wherein repurposing the receive request into the memory barrier request is performed in-place by using a handle of the receive request to perform a memory barrier operation.

5. The method of claim 1, wherein determining that the receive request involved a multi-hop intra-node transport path comprises determining that the receive request was sent through a proxy exchange network (PXN) interface configured to manage intra-node message forwarding between processing devices.

6. The method of claim 1, wherein the receiving processing device belongs to a host comprising a plurality of processing devices and R-NICs, and wherein determining that the receive request involved a multi-hop intra-node transport path comprises:
analyzing a topology map of a host to determine proximity among processing devices and R-NICs.

7. The method of claim 6, further comprising:
determining that a message transfer route includes a proxy GPU connected via a high-bandwidth intra-node interconnect distinct from PCIe.

8. The method of claim 1, wherein the multi-hop intra-node transport path is created responsive to detecting PCIe link contention or subtrees by selecting a proxy processing device that is topologically closer to a target R-NIC and routing message data between devices through a high-bandwidth intra-node interconnect.

9. The method of claim 1, wherein the receive request has a request identifier and the receive request retains the request identifier responsive to repurposing the receive request into a memory barrier request.

10. A non-transitory computer readable storage medium storing instructions that when executed by one or more computer processors cause the one or more computer processors to perform steps comprising:
receiving, via an RDMA network interface card (R-NIC), a receive request comprising message data destined for a target processing device, the message data stored in a proxy buffer on a receiving processing device;
determining that the receive request was transmitted via a multi-hop intra-node transport path;
responsive to determining that the receive request was transmitted via a multi-hop intra-node transport path, repurposing the receive request into a memory barrier request, wherein the memory barrier request is configured to commit message data of the receive request to the proxy buffer before further processing of the message data;
performing a gather operation to transfer the message data from the proxy buffer on the receiving processing device to the target processing device; and
reporting completion of the receive request to an application layer.

11. The non-transitory computer readable storage medium of claim 10, wherein the memory barrier request is for performing one of a memory fence operation or a memory flush operation.

12. The non-transitory computer readable storage medium of claim 10, wherein the receive request is a first receive request, the method further comprising:
receiving, at the receiving processing device a second receive request;
determining that the second receive request corresponds to a single-hop transfer; and
responsive to determining that the second receive request corresponds to a single-hop transfer, allowing the receive request to complete without repurposing the receive request to the memory barrier request.

13. The non-transitory computer readable storage medium of claim 10, wherein repurposing the receive request into the memory barrier request is performed in-place by using a handle of the receive request to perform a memory barrier operation.

14. The non-transitory computer readable storage medium of claim 10, wherein determining that the receive request involved a multi-hop intra-node transport path comprises determining that the receive request was sent through a proxy exchange network (PXN) interface configured to manage intra-node message forwarding between processing devices.

15. The non-transitory computer readable storage medium of claim 10, wherein the receiving processing device belongs to a host comprising a plurality of processing devices and R-NICs, wherein determining that the receive request involved a multi-hop intra-node transport path comprises:
analyzing a topology map of a host to determine proximity among processing devices and R-NICs.

16. The non-transitory computer readable storage medium of claim 15, further comprising:
determining that a message transfer route includes a proxy GPU connected via a high-bandwidth intra-node interconnect distinct from PCIe.

17. The non-transitory computer readable storage medium of claim 10, wherein the multi-hop intra-node transport path is created responsive to detecting PCIe link contention or subtrees by selecting a proxy processing device that is topologically closer to a target R-NIC and routing message data between devices through a high-bandwidth intra-node interconnect.

18. The non-transitory computer readable storage medium of claim 10, wherein the receive request has a request identifier and the receive request retains the request identifier responsive to repurposing the receive request into a memory barrier request.

19. A computer system comprising:
one or more computer processors; and
a non-transitory computer readable storage medium storing instructions that when executed by one or more computer processors cause the one or more computer processors to perform steps comprising:
receiving, via an RDMA network interface card (R-NIC), a receive request comprising message data destined for a target processing device, the message data stored in a proxy buffer on a receiving processing device;
determining that the receive request was transmitted via a multi-hop intra-node transport path;
responsive to determining that the receive request was transmitted via a multi-hop intra-node transport path, repurposing the receive request into a memory barrier request, wherein the memory barrier request is configured to commit message data of the receive request to the proxy buffer before further processing of the message data;
performing a gather operation to transfer the message data from the proxy buffer on the receiving processing device to the target processing device; and
reporting completion of the receive request to an application layer.

20. The computer system of claim 19, wherein the receive request is a first receive request, the method further comprising:
receiving, at the receiving processing device a second receive request;
determining that the second receive request corresponds to a single-hop transfer; and
responsive to determining that the second receive request corresponds to a single-hop transfer, allowing the receive request to complete without repurposing the receive request to the memory barrier request.
